(19) United States
(12) Patent Application Publication
(10) Pub. No.: US 2004/0257085 A1
(43) Pub. Date: Dec. 23, 2004

(54) Sampling of combined (tangled) electric near fields in hybrid and DIS ignitions

(76) Inventors: Kenneth A. McQueeney, Los Gatos, CA (US); David G. Capitolo, Fremont, CA (US)

Correspondence Address: MCDERMOTT, WILL & EMERY, 600 13th Street, N.W., Washington, DC, 20005-3096, US

(21) Appl. No.: 10/825,211

(22) Filed: Apr. 16, 2004

Related U.S. Application Data
(60) Provisional application No. 60/463,310, filed on Apr. 17, 2003.

(51) Int. Cl. F02P 17/00; F02P 3/06

(52) U.S. Cl. 324/402

(57) ABSTRACT

A capacitive probe for simultaneously detecting a plurality of electric near fields present proximate a hybrid or DIS ignition under test during operation of the hybrid ignition, the hybrid or DIS ignition having a first output to a first spark plug and a second output to a second spark plug. The probe includes a base configured for removable attachment to an ignition housing by means of an interference fit and a single capacitive sensor fixed to the base. The sensor is disposed on the base and has an electrical lead connected thereto. The probe simultaneously detect a first electric near field developed by a first high voltage signal in a hybrid or DIS ignition first output to a first spark plug and a second electric near field developed by a second high voltage signal in a hybrid or DIS ignition second output to a second spark plug and outputs a corresponding signal including a positive-going signal component from the first electric near field and a negative-going signal component from the second electric near field.

### CROSS REFERENCE TO RELATED APPLICATIONS

This application claims priority from and is related to U.S. Provisional Application No. 60/463,310, filed Apr. 17, 2003, entitled “HYBRID COP SAMPLING OF COMBINED (TANGLED) ELECTRIC FIELDS”, by inventors Kenneth A. McQueeney and David G. Capitolo, (Attorney Docket No. 66396-032). The contents of the provisional application are hereby incorporated by reference in its entirety.

### BACKGROUND

1. Field

This patent application is directed to the field of ignition coils. It is more specifically directed to a capacitive-coupled sensor for hybrid ignition coils and more particularly to such probe configured for placement in electric near fields proximate a hybrid ignition coil as a means of sensing the signals that are delivered to spark plugs by the coil.

2. Description of Related Art

Ignition coils are commonly used in internal combustion engines to boost a low voltage supply voltage to the very high voltage level that is necessary to initiate and sustain a spark across a spark plug gap of a spark plug. The spark ignites a fuel-air mixture in an associated engine cylinder, causing increased pressure in the cylinder which produces movement of a piston within the cylinder. Historically, a single ignition coil was used in combination with a distributor to supply the high voltage needed by the spark plugs. The distributor was connected between the ignition coil and the spark plugs to sequentially distribute, using a rotor, the high voltage generated by the ignition coil to each of the spark plugs.

The ignition coil itself is, essentially, a transformer having a very large turn ratio, typically between 1:50 to 1:100, between the primary and secondary, which transforms the low voltage in a primary winding provided by the sudden opening of the primary current to a high voltage in a secondary winding. In older ignition systems, the ignition coil is connected to the center or coil terminal of a distributor cap by an insulated wire. High voltage from the ignition coil is distributed from the coil terminal to side or spark plug terminals of the distributor cap by means of a rotor. As the tip of the rotor spins in the cap past a series of contacts (one contact per cylinder), a high-voltage pulse from the coil arcs across the small gap between the rotor and the contact and continues down the spark-plug wire to the spark plug on the appropriate cylinder, thus distributing the spark to each spark plug terminal at a predetermined timing.

More recently, ignition systems have evolved to “distributorless” ignition systems having one ignition coil per cylinder (e.g., conventional coil-on-plug (COP)) or one ignition coil per cylinder pair (e.g., a direct ignition system (DIS) or Hybrid). Distributorless ignition systems, as the name implies, do not utilize distributor caps or rotors and, instead, incorporate an ignition coil over each plug (or plug pair) or an ignition coil near each plug (coil near plug or CNP)(or plug pair). The ignition coil generates the high voltage and supplies it only to the single spark plug (e.g., COP) or spark plug pair (e.g., DIS or Hybrid) with which it is associated. Coil-on-plug (COP) ignitions generally comprise an ignition coil integrally mounted on spark plug and is mounted to the engine cylinder or engine block with the spark plug gap protruding into the engine cylinder. The spark coil conducts high voltage direct current to the spark plug and spark plug gap using internal connections.

Some distributorless ignition systems (e.g., hybrid) are configured so that at least one of the two plugs in the pair is buried or otherwise inaccessible (e.g., one plug is a COP), whereas other distributorless ignition systems (e.g., DIS) are configured so that both plugs in the pair are accessible. Thus, in the hybrid ignition system, the ignition coil may be connected to one spark plug by a conventional ignition wire and to the other companion spark plug by means of a direct connection (e.g., a COP connection, such as a semi-rigid conductive extension or bus protruding from the bottom of the ignition coil to the spark plug). Thus configured, the hybrid ignition secondary coil generates a high voltage signal which is simultaneously output to the associated COP and companion spark plug. The hybrid ignition secondary coil also generates an electric near field which may be detected by an appropriately configured sensor, such as but not limited to that shown in U.S. Pat. No. 6,396,277, the content of which is incorporated herein by reference. The information obtained and output by the sensor may be used to develop waveforms of the ignition cycle to aid in detection of and diagnosis of ignition system anomalies.

A single signal detector is often used to detect the signals on each spark plug. The process usually begins with a technician clipping or placing the signal detector adjacent the housing of a first ignition coil. When the engine is operated, the (secondary) ignition coil generates an electric near field each time the ignition coil provides a high voltage to the spark plug to initiate a spark. The voltage of this electric near field is typically proportional to the voltage that the ignition coil delivers to the spark plug. The signal detector detects this electric near field and the detected signal may be processed to extract the most relevant information and the results reported to the technician. The signal detector is then moved to the next hybrid ignition coil and the process repeated.

However, since the hybrid coil generates and outputs two different polarity high voltage signals, two separate near electric fields are correspondingly present. When analyzing the operation of the combustion engine cylinders associated with the hybrid ignition coil, it has been heretofore necessary to separately detect both fields that are being present proximate the hybrid ignition coil. Prior art signal detectors are not capable of simultaneously detecting the two separate fields from a single hybrid or DIS ignition coil.

### SUMMARY

This patent application is directed to a probe, detection process and diagnostic system for detecting a combined electric field resulting from the near electric fields present proximate hybrid ignition coils.

A capacitive probe for simultaneously detecting a plurality of electric near fields present proximate a hybrid or DIS ignition under test during operation of the hybrid ignition, the hybrid ignition having a first output to a first spark plug and a second output to a second spark plug. The probe includes a base configured for removable attachment to a hybrid ignition under test and a single capacitive sensor disposed on the base with an electrical lead connected thereto. The probe is configured to simultaneously detect a first electric near field developed by a first high voltage signal in a hybrid ignition first output to a first spark plug and a second electric near field developed by a second high voltage signal in a hybrid ignition second output to a second spark plug. The signal output from the capacitive sensor comprises a positive-going signal component from one of the first electric near field and second electric near field and a negative-going signal component from the other one of the first electric near field and second electric near field.

In another aspect, a method for simultaneously detecting a plurality of electric near fields present proximate a hybrid or DIS ignition coil housing, is provided and includes the steps of providing a capacitive probe comprising a body and a single capacitive signal detector and placing the single capacitive signal detector proximate an exterior of a hybrid ignition coil housing at a position corresponding to an overlap of a first electric near field corresponding to a first output of a hybrid ignition coil under test and a second electric near field corresponding to a second output of a hybrid ignition coil under test, the first and second electric near fields being generated when each of the first and second outputs are at a high voltage corresponding to at least a portion of an ignition spark. The method includes using the capacitive signal detector to simultaneously detect the first electric near field the second electric near field and outputting from the single capacitive signal detector a signal representative of the first electric near field and the second electric near field. The signal output from the capacitive sensor comprises a positive-going signal component from one of the first electric near field and second electric near field and a negative-going signal component from the other one of the first electric near field and second electric near field.

Other aspects and advantages of the present disclosure will become apparent to those skilled in this art from the following description of preferred aspects taken in conjunction with the accompanying drawings. As will be realized, the disclosed concepts are capable of other and different embodiments, and its details are capable of modifications in various obvious respects, all without departing from the spirit thereof. Accordingly, the drawings, disclosed aspects, and description are to be regarded as illustrative in nature, and not as restrictive.

### BRIEF DESCRIPTION OF THE DRAWINGS

FIG. 1 is a perspective view of a hybrid ignition coil to which the probe is attached for the purpose of detecting near electric fields present proximate the coil;

FIGS. 2A, 2B and 2C are perspective views of the probe;

FIG. 2D is a perspective view of the probe shown in FIGS. 2A, 2B and 2c attached to the hybrid ignition coil shown in FIG. 1;

FIG. 3 is a waveform showing normal signals detected by the probe;

FIGS. 4-7 waveforms showing abnormal signals detected by the probe; and

FIG. 8 illustrates a diagnostic system for detecting and reporting on the electromagnetic field that is present proximate the hybrid ignition coil.

### DETAILED DESCRIPTION

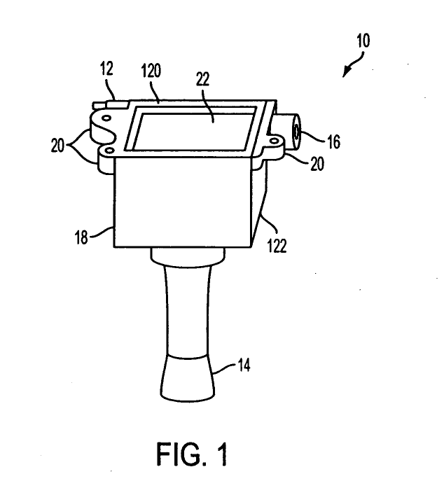

FIG. 1 is a perspective view of a hybrid ignition coil 10 such as the Model No. FL0162 available from Mitsubishi Electric Mfg. Corporation. Generally, hybrid ignition coil 10 is used in a hybrid ignition system, which is a distributorless ignition system (“DIS”). In a hybrid ignition system, a single coil is used to fire two spark plugs. One plug is connected to the ignition coil in a coil-over-plug (“COP”) configuration, in which the plug is connected to the ignition coil via a rigid extension protruding from the housing of the ignition coil. The other plug may be conventionally mounted to the engine and connected to the hybrid ignition coil by an ignition wire. This plug is called the companion plug.

As shown in FIG. 1, hybrid ignition coil 10 may include an input connector 12 into which a low input voltage is ignited. This is typically 12 volts, although different voltages also may be used. Input connector 12 is sometimes configured to also receive a control signal, separate from the low input voltage. In these situations, an electronic switch (not shown) inside the hybrid ignition coil 10 acts to deliver the low input voltage to the ignition coil when so instructed by the control signal. In other situations, there is no control signal and the power signal is controlled externally and only delivered to the ignition coil when firing of the spark plugs connected to it is desired.

The hybrid ignition coil 10 may include a first output terminal 14 that is typically connected to a first spark plug (not shown) of a pair of plugs that serves as the COP-configured plug. The hybrid ignition coil 10 may also include a second output terminal 16 that is typically connected to the second, companion spark plug (not shown) of the pair through an ignition wire.

The hybrid ignition coil 10 may also include an ignition coil (not visible) housed in a housing 18. The ignition coil typically consists of a primary winding that is connected to the low voltage input 12 and a secondary winding that is electrically connected to the COP and companion plugs through output wires 14 and 16, respectively. As is well known, the number of turns in the secondary winding is usually many multiples of the number of turns in the primary winding to facilitate the voltage boost function of the ignition coil.

As is well known and should be apparent, the housing 18 can have a broad variety of shapes and configurations. This particular housing 18 includes a cavity 22 which, as is described below, enables the sensor to be placed proximate the signals which are detected. As is also well known, the housing 18 is typically secured to the engine by inserting the output wire 14 into the spark plug cylinder and by tightening one or more bolts (not shown) that are channeled through one or more connecting flanges 20 into the engine.

In normal operation of the hybrid ignition 10 and the associated engine, the pair of spark plugs that are controlled by the hybrid ignition are operated in a reciprocal fashion. In other words, when the cylinder associated with the first spark plug (e.g., a COP spark plug) is in its compression stroke, the cylinder associated with the second or companion spark plug is in its exhaust stroke. When the cylinder associated with the first spark plug is in its exhaust stroke, the cylinder associated with the companion spark plug is in its compression stroke.

In operation, the hybrid ignition coil 10, upon receiving the low input voltage at the primary winding, as described above, generates a positive-going high voltage signal at one end of the secondary coil and a negative-going high voltage signal at the other end of the secondary coil. In the case of the hybrid ignition coil shown in FIG. 1, the positive-going high voltage signal is delivered to the COP plug via output wire 14 and the negative-going high voltage signal is delivered to the companion plug via output wire 16. As both the positive and negative-going high voltage signals are generated, a near electric field is generated within the housing 18. One of the near electric fields is proportional to the electric field supplying the positive-going voltage to the COP plug and the other near electric field is proportional to the electric field supplying the negative-going voltage to the companion plug.

While it is possible to separately sense each near electric field with a separate sensor, as is conventionally done, the inventor has discovered that it is also possible to obtain the desired information from the positive and negative-going voltages by placing a capacitive sensor at a position relative to the hybrid ignition coil 10 where the two separate near electric fields are combined with each other, or “tangled.” By measuring this combined electric field, information about the operation of the ignition system may be obtained. It will be understood, however, that the probe may be used in connection with hybrid ignition coils that operate the COP spark plug with a negative-going voltage and the companion spark plug with a positive-going voltage. The particular polarity of the output voltage is not germane to the operation of the probe.

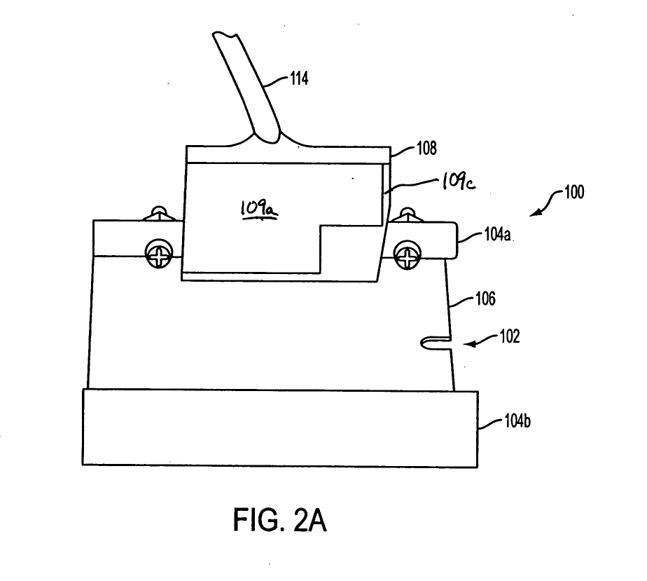

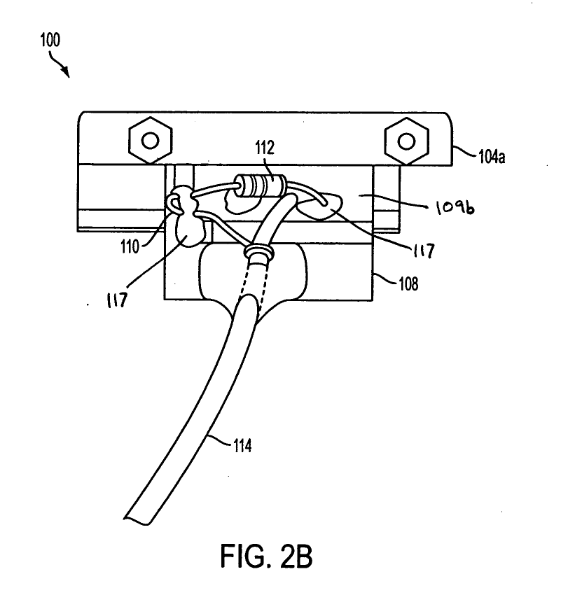

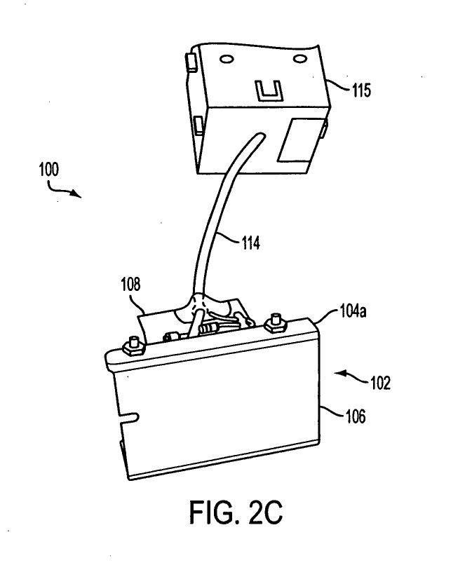

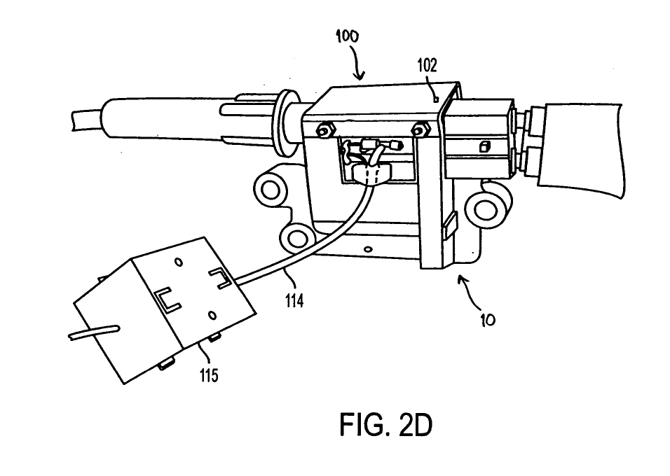

FIGS. 2A-2C illustrate one example of a probe 100 that may be used to detect the near electric fields present proximate the hybrid ignition coil 10. This exemplary probe 100 includes a U-shaped body 102 including side portions 104a and 104b. FIGS. 2A-2B show a probe 100 including a capacitive-coupled signal sensor 108 comprising opposing capacitive metallizations 109a, 109b separated by a dielectric layer 109c mounted on side portion 104a in a fixed relation to the probe body 102. The capacitive probe 100, thus configured, is able to simultaneously detect a plurality of electric near fields which are present near a hybrid ignition under test during operation of the hybrid ignition. If the capacitive probe 100 is designed for a specific hybrid ignition or family of hybrid ignitions having a housing of a known or pre-determined configuration, the body or base 102 may be configured to provide an interference fit with at least two opposing surfaces of the hybrid ignition housing, thus proving a simple means by which the probe may be removably attached to the housing.

In this example, the capacitive sensor 108 is fixed to the base adjacent an exterior of the hybrid ignition housing in a location adjacent the secondary ignition coil or secondary ignition coil output to a first spark plug (e.g., the output to a COP spark plug may not be directly accessible) to detect an electric near field corresponding to the voltage provided to this first spark plug. The capacitive sensor 108 is also fixed to the base adjacent an exterior of the hybrid ignition housing in a location adjacent the secondary ignition coil output to a second or companion spark plug to detect an electric near field corresponding to the voltage provided to this second spark plug. Thus, the capacitive sensor 108 is positioned within a space wherein the first electric near field and the second electric near field overlap so as to be able to simultaneously detect a first electric near field developed by a first high voltage output (e.g., a voltage provided to a COP spark plug) and a second electric near field developed by a second high voltage output to a second spark plug (e.g., a companion plug).

A signal output from the capacitive sensor 108 will comprise a positive-going signal component from one electric near field (e.g., the first secondary coil) and a negative-going signal component from the other electric near field (e.g., the second secondary coil).

The capacitive-coupled signal sensor 108 may be formed, for example, from a capacitive plate mounted to the positioning member 104. The capacitive-coupled signal sensor 108 may, however, include any capacitive sensing device such as, but not limited to that disclosed in U.S. Pat. No. 6,396,277, the content of which is incorporated herein by reference.

FIG. 2D illustrates the probe 100 mounted on the hybrid ignition coil 10. As shown in FIG. 2D, probe 100 is mounted to the hybrid ignition coil 10 by an interference fit between side portions 104a and 104b of the U-shaped body 102 and upper portion 120 and lower portion 122 of the housing 18 of the hybrid ignition coil 10, FIG. 1. Capacitive-coupled sensor 108 is mounted to side portion 104a in a position that enables proper alignment of the capacitive sensor within cavity 22 of housing 18 of the hybrid ignition coil 10, so as to be oriented to detect the combined electric field. In other words, the capacitive sensor 108 is placed on a portion 22 of the housing 10 adjacent the secondary ignition coil and adjacent an output (e.g., 16) to the companion spark plug (see FIGS. 1, 2D). In this position, the electric near fields for the voltages associated with each of the first spark plug (e.g., COP spark plug) and second spark plug (e.g., companion plug) overlap. Preferably, the capacitive sensor 108 is placed on a portion 22 of the housing 10 adjacent the secondary ignition coil and adjacent an output wherein the strength of the signals is approximately equal. The exact placement of the capacitive sensor 108 is limited only by the ability of the combination of the capacitive sensor 108 and the attached diagnostic equipment to detect both signals and output a waveform or combined waveform sufficient to enable differentiation of and analysis of the separate spark plug events of interest, such as firing line, burn time, and spark line.

Capacitive sensor 108 may be configured to move between at least a first position and a second position along one axis (e.g., side-to-side, front-to-back, up-down, or even about a rotational axis etc.) or more than one axis relative to the base 102 so as to permit the capacitive sensor position to be adjusted over a range of positions. Capacitive sensor 108 may be initially placed at a first location such as near a known location of a first electric field (e.g., an output to a companion spark plug) or even an arbitrary point. The capacitive sensor 108 may then be moved about the outer surfaces of the housing of the hybrid ignition under test 10 until a satisfactory representation (e.g., suitable amplitude and readability) of each of the two electric near fields (e.g., one positive-going and the other negative-going) is displayed on the output or diagnostic device (e.g., a lab scope or MODIS®, available from Snap-On® Diagnostics of San Jose, Calif.).

The aforementioned ability of at least one example of capacitive sensor 108 to move between at least a first position and a second position along one axis (e.g., side-to-side, front-to-back, up-down, etc.) or more than one axis relative to the base 102 may be achieved, for example, by providing a slidable tongue member which fits within a first groove on or in the probe body 102. A screw, clamp, or other locking or biasing means may then be used to secure the capacitive sensor 108 relative to the probe body. In another example, a plurality of connection points, which may range from a few connection points to dozens or hundreds of connection points (e.g., a linear or matrix array), may be provided to enable the capacitive sensor 108 to be relocated from one connection point and inserted in another connection point. The sensor 108 may also attached to a movable element, such as an arm that is positionable along one or more than one axes relative to the probe body 102.

While the probe shown in the figures is configured to be mounted to the hybrid ignition coil shown in FIG. 1, it will be understood that the probe body or base 102 may assume other shapes so as to permit placement of the capacitive sensor 108 borne thereby to sense both electric near fields one or more hybrid ignition housings. Thus, the base 102 may assume any shape such as, but not limited to, a flat plate, a curved plate, or an angled plate, since the attachment device is not limited to an interference fit, as shown in the example of FIGS. 2A-2C. In such configurations, an attachment device may be configured to removably attach the base 102 to the hybrid ignition housing in a position which places the capacitive sensor 108 in an area of overlapping electric near fields, the overlapping electric near fields being generated by the high voltages provided to both spark plugs (e.g., a COP spark plug and a companion spark plug) during at least a portion of a spark event in a hybrid ignition coil under test. The base 102 may be attached to the housing of a hybrid ignition under test 10 by any suitable means. In various aspects, the attachment means may comprise a high-friction surface, a clamp, a magnetic clip or magnetic member, a spring clip or other clip, screw members, pins, straps, or recesses corresponding to protuberances on the housing of the hybrid ignition under test, in addition to other conventional attachment means. The attachment means is not limited to direct attachment to the housing and may alternatively attach to other engine components, other components in the engine compartment, or even the underside of the hood.

The capacitive probe 100 body 102 may be formed from any suitable material such as, but not limited to, a hardened stainless steel, a non-magnetic metal or alloy, or a plastic or polymer (e.g., a rigid polymer, such as Nylatron GS). Capacitive sensor 108 may be formed from any suitable capacitive materials comprising plates, windings, or metallizations of electrically-conductive material, metal, or alloys such as, but not limited to, copper.

Probe 100 may also include a ferrite core clamp-on suppressor 115 coupled to cable 114 which acts to prevent spurious oscillations which typically occur in analog, high impedance, high frequency circuits. The suppressor 115 acts as a one-turn inductor over a range of high frequencies which reduces loop gain to less than one. The suppressor 115 may also be configured to provide a loop gain above one and the unwanted signal elements may simply be filtered out. To compensate for differences in the magnitudes of the positive-going high voltage signal and the negative-going high voltage signal, capacitive-coupled signal sensor 108 may include a capacitor 110 and/or resistor 112 which may be coupled to the signal sensor, such as by soldered connections 117, to equalize the detected signal.

Probe 100 further includes output cable 114 electrically connected to capacitive-coupled sensor 108. As described below, the probe 100 output cable is connected via conventional electrical connectors (e.g., cables bearing phono-connectors) or data output means (e.g., carrier wave transmission device) to analysis equipment, such as the Snap-On® MODIS® or a lab scope (e.g., TEK 2), to provide a visual representation of the detected combined electric field.

As described above, one purpose of the capacitive sensor 108 is to detect the combined field that is present proximate the hybrid ignition coil. The capacitive sensor 108 converts the electric near fields into an electric signal deliverable to analysis equipment over output cable 114 or other output means, such as but not limited to IR, RF, single side-band transmission devices, packet transmission devices, or other carrier-wave transmission devices.

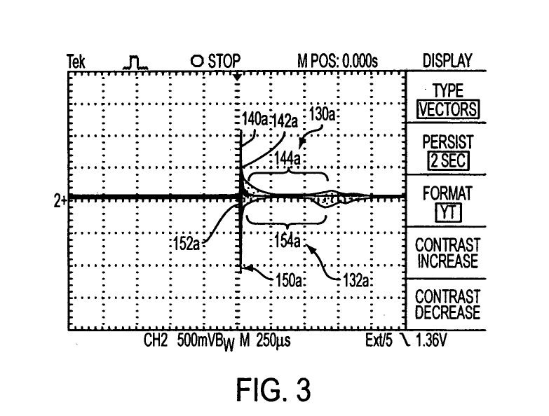

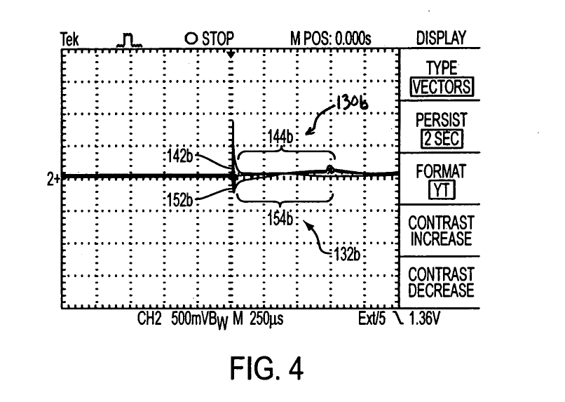

FIG. 3 illustrates waveforms that selectively display the detected electric near fields associated with the spark event in the compression stroke of each of the COP spark plug and a companion spark plug during normal operation of an engine. FIGS. 4-7 illustrate waveforms that show the detected electromagnetic fields associated with the spark event in the compression stroke of each of the COP spark plug and a companion spark plug during abnormal operation of an engine.

In FIG. 3, the upper waveform 130 is that of the positive-going signal associated with the spark event in the compression stroke of the COP spark plug and the lower waveform 132 is that of negative-going signal associated with the spark event in the compression stroke of the companion spark plug. Thus, FIGS. 3-7 show upper and lower waveforms which are not simultaneous to facilitate analysis by a technician. A sensed amplitude for the COP plug (positive going) is displayed during a first sweep and is followed by display of a sensed amplitude of the companion plug (negative going) on a second sweep. The sweeps continue to alternate between these two conditions. The persistence of human vision is sufficiently long that individual sweeps cannot generally be resolved. In many scopes, the print command will output the sweep displayed at the exact instant the command is processed. To print both traces simultaneously, the display persistence of the scope on which the waveforms are displayed may be set to a high value, such as 2 seconds. This is not necessarily germane to the operation of the capacitive sensor 108 or probe 100, and it is to be understood that the waveforms may be analyzed based on separate displays of the positive and negative-going waveforms and may be analyzed in combination with the waste spark signals, as well.

FIG. 3 shows a waveform 130a which represents the “normal” positive-going signal associated with the COP cylinder and a waveform 132a which represents the “normal” negative-going signal associated with the companion plug. Waveform 130a shows, for example, the firing line 140a, spark line 142a, and burn time 144a. Waveform 132a shows firing line 150a, spark line 152a, and burn time 154a of the companion cylinder. The waveforms shown in FIG. 3 are used in the diagnostic testing of an engine to determine whether an engine under test is operating properly by comparing the waveforms obtained during a test to these waveforms 130a and 132a.

FIG. 4 shows waveforms 130b and 132b which represent the signals detected by capacitive probe 100. When waveforms 130b and 132b of FIG. 4 are compared to the “normal” waveforms shown in FIG. 3, it is apparent that the burn times 144b, 154b (FIG. 4) are higher than that of 144a, 154a (FIG. 3). The spark line 152b for the companion cylinder in FIG. 4 is less than the “normal” spark line 152a (FIG. 3). If the burn times are greater than the manufacturer's recommended operating range for the particular hybrid ignition coil under test (e.g., about 30% greater), the burn time test data suggests that the COP or companion spark plug or wiring is shorted or fouled. To determine which plug or wiring is at fault, it is necessary to determine which spark line 142b or 152b is approximately one-half of the “normal” amplitude represented in FIG. 3. This additional information will identify the faulty plug or wiring. In this example, because the spark line 152b of the companion cylinder is approximately one-half of the “normal” spark line 152a of waveform 132a in FIG. 3, the companion plug or wiring is likely shorted or fouled. Generally, if the companion cylinder has a low or missing negative going portion of the waveform, as compared to the corresponding normal waveforms of FIG. 3, there is likely a problem with low compression, a bad injector, or shorted/fouled plug and/or wiring.

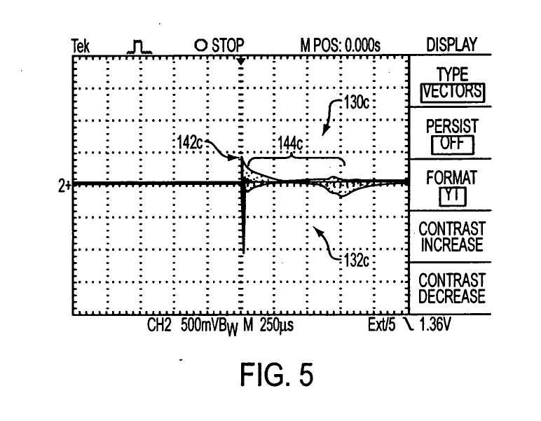

FIG. 5 shows waveforms 130c and 132c which represent the signals detected from the probe 100 when a short is present in the COP plug gap. When the waveforms 130c, 132c of FIG. 5 are compared to the “normal” waveforms of FIG. 3, the spark line 142c of waveform 130c is seen to be less than the “normal” spark line 142a and the burn time 144c is greater than the “normal” burn time 144a. Generally, if the COP cylinder has a low or missing positive going portion of the waveform, as compared to the normal waveforms of FIG. 3, there is likely a problem with low compression, a bad injector, or shorted/fouled plug and/or wiring.

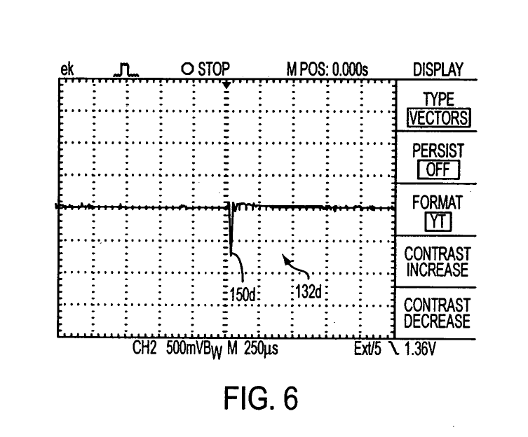

FIG. 6 shows a waveform 132d which represents the signal detected when an open circuit is present in the companion plug circuit. The vertical scale of the waveform has been adjusted, compared to FIGS. 3-5, from 500 mV/div to 2.00 V/div to show the entire firing line on the display. The waveform associated with the companion plug is not shown in FIG. 6. A negative-going firing line 150d in the companion waveform 132d which is much greater than the normal negative-going firing line indicates on open condition in the companion cylinder circuit. The deviation from “normal” may be determined with reference to other like cylinders in adjacent hybrid ignition coil housings, to manufacturer's or third-party hybrid ignition coil data, and/or to the operator's own experience with a particular hybrid ignition coil arrangement.

It is not necessary for the deviation of the measured firing line from the “normal” firing line to be a specific minimal amount to indicate a degraded or faulty condition in the plug and/or wiring. Any deviation from the normal signal may indicate that further investigation into the performance of the plug and/or wiring may be warranted by the operator of the system. Likewise, it is understood that deviations of 20-30% or more may not indicate a problem. Often, the technician must rely on other indicia of ignition system and engine operation, in combination with the measured spark characteristics or data, to make an accurate assessment of the ignition system condition.

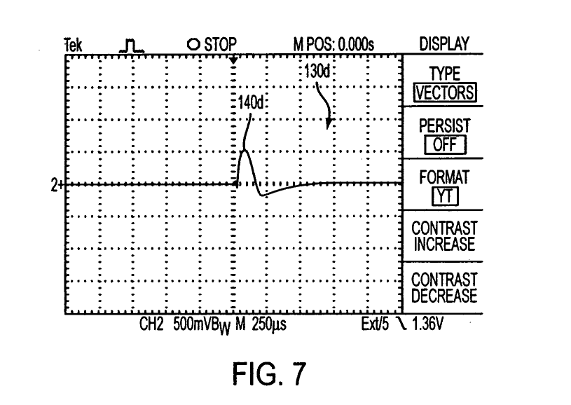

FIG. 7 shows a waveform 130d which represents the signal detected when an open circuit is present in the COP plug circuit. Again, the scale of the waveform has been adjusted, compared to FIGS. 3-5, from 500 mV/div to 2.00 V/div to show the entire firing line 140d on the display. The waveform associated with the companion plug is not shown in FIG. 7. A greater than normal firing line 140d, as compared to that of the “normal” COP waveform 140a, indicates on open condition in the COP cylinder circuit. Again, it is not necessary for the deviation of the measured firing line from the “normal” firing line to be a specific amount of deviation from the normal signal for the plug or wiring to be labeled as faulty. Any deviation from the “normal” signal, such as compared to other like cylinders in adjacent hybrid ignition coil housings, to manufacturer's or third-party hybrid ignition coil data, and/or to the operator's own experience with a particular hybrid ignition coil arrangement, may dictate further analysis of the plug and/or wiring.

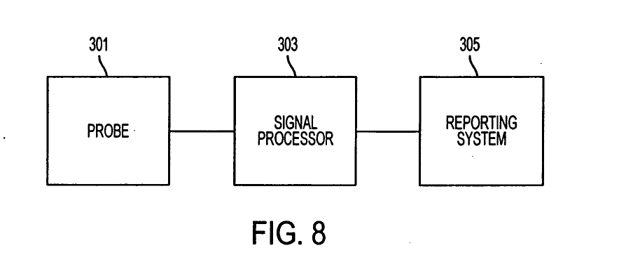

FIG. 8 illustrates a diagnostic system for detecting and reporting on the fields that are present proximate the hybrid ignition coil. As shown in FIG. 8, a probe 301, such as one of the probes described above, may be connected to a signal processor 303 which, in turn, may be connected to a reporting system 305. The raw signals that come from the probe 301 may be processed by the signal processor 303 to extract or to emphasize the most common types of needed information or to convert the signal into another form (e.g., carrier wave signal). As one example, the signal processor 303 could analyze the signal from the probe 301 for determining the burn time or spark duration and firing line of the plugs.

The output of these determinations could be delivered to the reporting system 305. The reporting system 305 could include a scope (e.g., a MODIS® diagnostic device) to display the signal emanating from the probe 301 and optional signal processor 303. Reporting system 305 could provide numerical values for or graphical representations of some or all of parameters of interest such as, but not limited to, burn time, firing line and spark line. Further details on how such an analysis could be performed and how the subsystems might cooperate are set forth in U.S. Pat. No. 6,396,277, the content of which is incorporated herein by reference.

Although the probe 301, signal processor 303, and reporting system are shown to be electrically connected via conventional electrical conductors, one or both of these connections may be effected by wireless connections.

The embodiments described herein may include or be utilized with any appropriate voltage or current source, such as a battery, an alternator, a fuel cell, and the like, providing any appropriate current and/or voltage, such as about 12 Volts, about 42 Volts and the like.

The embodiments described herein may be used with any desired system or engine. Those systems or engines may comprises items utilizing fossil fuels, such as gasoline, natural gas, propane and the like, electricity, such as that generated by battery, magneto, fuel cell, solar cell and the like, wind and hybrids or combinations thereof. Those systems or engines may be incorporated into other systems, such as an automobile, a truck, a boat or ship, a motorcycle, a generator, an airplane and the like.

I claim:

1. A capacitive probe for simultaneously detecting a plurality of electric near fields present proximate a hybrid or DIS ignition under test during operation of the hybrid ignition, the hybrid or DIS ignition having a housing of a predetermined configuration, a first output to a first spark plug and a second output to a second spark plug, the capacitive probe comprising:
a base configured for removable attachment to a hybrid or DIS ignition under test,
a single capacitive sensor disposed on the base, the capacitive sensor having an electrical lead connected thereto,
wherein the capacitive probe is configured to simultaneously detect a first electric near field developed by a first high voltage signal in a hybrid or DIS ignition first output to a first spark plug and a second electric near field developed by a second high voltage signal in a hybrid or DIS ignition second output to a second spark plug, and
wherein the signal output from the capacitive sensor comprises a positive-going signal component from one of the first electric near field and second electric near field and a negative-going signal component from the other one of the first electric near field and second electric near field.

2. A capacitive probe for simultaneously detecting a plurality of electric near fields present proximate a hybrid or DIS ignition under test during operation of the hybrid or DIS ignition according to claim 1, wherein the base is configured to provide an interference fit with at least two opposing surfaces of the hybrid or DIS ignition housing.

3. A capacitive probe for simultaneously detecting a plurality of electric near fields present proximate a hybrid or DIS ignition under test during operation of the hybrid or DIS ignition according to claim 1, further comprising:
a fastening device to removably fasten the capacitive probe base to a hybrid or DIS ignition coil housing, and
wherein the single capacitive sensor is configured to move between at least a first position and a second position along at least one axis relative to the base so as to permit the capacitive sensor to be positioned between a first output of a hybrid or DIS ignition coil under test to a first spark plug and a second output of a hybrid or DIS ignition coil under test to a second spark plug, the capacitive sensor having an electrical lead connected thereto.

4. A capacitive probe according to claim 3, wherein the base is adjustable to accommodate a plurality of housing configurations.

5. A capacitive probe according to claim 4, wherein the base is substantially U-shaped.

6. A capacitive probe according to claim 4,
wherein the base comprises a first portion and a second portion, two portions being movable relative to each other,
wherein the base comprises a first locking member for locking the first portion and a second portion together.

7. A capacitive probe according to claim 6,
wherein each of the first portion and the second portion have, in combination, a substantially U-shaped cross-section along one axis.

8. A capacitive probe according to claim 3, wherein the probe comprises a second locking member one at least one of the base and the capacitive sensor to lock the capacitive sensor in at least one of the first position, the second position, and a position between the first position and second position.

9. A capacitive probe according to claim 3, further comprising:
at least one of a capacitor and a resistor electrically coupled to the capacitive probe to substantially equalize the magnitudes of the signal components output from the capacitive probe corresponding to the detected first and second electric near fields.

10. A capacitive probe according to claim 4, further comprising:
a ferrite-core suppression device coupled to the electrical lead to mitigate spurious signal oscillations.

11. A capacitive probe according to claim 10, wherein the suppression device comprises an inductive device adapted to reduce loop gain to less than unity over a range of high frequencies.

12. A method for simultaneously detecting a plurality of electric near fields present proximate a hybrid or DIS ignition coil housing, comprising the steps of:
providing a capacitive probe comprising a body and a single capacitive signal detector;
placing the single capacitive signal detector proximate an exterior of a hybrid or DIS ignition coil housing at a position corresponding to an overlap of a first electric near field corresponding to a first output of a hybrid or DIS ignition coil under test and a second electric near field corresponding to a second output of a hybrid or DIS ignition coil under test, the first and second electric near fields being generated when each of the first and second outputs are at a high voltage corresponding to at least a portion of an ignition spark;
using the single capacitive signal detector to simultaneously detect the first electric near field the second electric near field; and
outputting from the single capacitive signal detector a signal representative of the first electric near field and the second electric near field.

13. A method for simultaneously detecting a plurality of electric near fields present proximate a hybrid or DIS ignition coil housing according to claim 12, wherein the placing step further comprises placing the single capacitive signal detector proximate an exterior of a hybrid or DIS ignition coil housing at a position between a first output of a hybrid or DIS ignition coil under test to a first spark plug and a second output of a hybrid or DIS ignition coil under test to a second spark plug.

14. A method for simultaneously detecting a plurality of electric near fields present proximate a hybrid ignition coil housing according to claim 13, further comprising the step of:
processing the signal output by the single capacitive signal detector using at least one of a signal processor and an amplifier.

15. A method for simultaneously detecting a plurality of electric near fields present proximate a hybrid or DIS ignition coil housing according to claim 14, further comprising the step of:
reporting the signal output by the single capacitive signal detector to at least one of a display device, a printing device, a communication device, and an electronic storage device.

16. A method for simultaneously detecting a plurality of electric near fields present proximate a hybrid or DIS ignition coil housing according to claim 14, further comprising the step of:
attaching the single capacitive signal detector proximate the first output and the second output of the housing of the hybrid or DIS ignition coil under test.

17. A method for simultaneously detecting a plurality of electric near fields present proximate a hybrid or DIS ignition coil housing according to claim 14, wherein the step of placing the single capacitive signal detector proximate the ignition coil housing comprises placing the single capacitive signal detector near a portion of the housing adjacent both the secondary ignition coil and one of the first output and the second output associated with a companion spark plug.

18. A method for simultaneously detecting a plurality of electric near fields present proximate a hybrid or DIS ignition coil housing according to claim 17, wherein the step of placing the single capacitive signal detector proximate the ignition coil housing comprises placing the single capacitive signal detector closer to the secondary ignition coil than one of the first output and the second output associated with a companion spark plug.

19. A method for simultaneously detecting a plurality of electric near fields present proximate an exterior of a hybrid or DIS ignition coil housing according to claim 18, wherein the step of placing the single capacitive signal detector proximate the ignition coil housing comprises placing the single capacitive signal detector closer one of the first output and the second output associated with a companion spark plug than to the secondary ignition coil.
